(19) United States
(12) Patent Application Publication
(10) Pub. No.: US 2008/0302664 A1
(43) Pub. Date: Dec. 11, 2008

(54) Apparatus for driving fluid

(75) Inventors: Cheng-Hsien Liu, Hsinchu (TW); Long Hsu, Hsinchu (TW); Kuang-Han Chu, Jhongli City (TW); William Wang, Taoyuan (TW); Chung-Cheng Chou, Taoyuan (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/155,274

(22) Filed: Jun. 2, 2008

(30) Foreign Application Priority Data
Jun. 6, 2007 (TW) 96120412

(51) Int. Cl. C02F 1/469

(52) U.S. Cl. 204/600

(57) ABSTRACT

An apparatus for driving a fluid includes a substrate, at least one electrode group and a controlling unit. The substrate has at least one plane. The electrode group is disposed on the substrate and includes a first electrode, a second electrode and a third electrode. A projecting position of the second electrode on the plane is disposed between that of the first electrode and that of the third electrode. The controlling unit electrically connected to electrode group is for driving the first to third electrodes. When the controlling unit drives the first to third electrodes to make the first and third electrodes have opposite polarities and to make the second and third electrodes have the same polarity, an electric field produced by the electrode group enables the fluid on the substrate to flow from the first electrode to the third electrode.

This application claims the benefit of Taiwan application Serial No. 96120412, filed Jun. 6, 2007, the subject matter of which is incorporated herein by reference.

### BACKGROUND OF THE INVENTION

1. Field of the Invention

The invention relates in general to a fluid driving apparatus, and more particularly to a fluid driving apparatus using an electro-osmotic force (EOF).

2. Description of the Related Art

Due to the development of the technique associated with the manufacturing process of the micro-electro-mechanical-system (MEMS), the concepts of a biometric chip and a biometric disc with many micro-channels have been gradually gazed at. The micro-channels usually have to cooperate with micro-pumps serving as the sources for driving the fluid.

The micro-pumps used in the MEMS are, for example, bubble-type pumps, membrane-type pumps, diffusing pumps and the like. The working principle of these pumps is to drive the fluid by the mechanical elements themselves. The mechanical elements with complicated structures in the micro-channels must have the very-fine dimensions, causing many restrictions to the MEMS.

The micro-channels must be capable of driving the fluid and controlling the movement of the particles at the same time. However, at present the micro-channels can only drive the fluid to flow but cannot change the moving direction of the particles during the movement.

### SUMMARY OF THE INVENTION

The invention is directed to a fluid driving apparatus for generating an electric field from an electrode or an electrode group, which is driven either independently or dependently. By the operation of the electrode group, charges are induced in the fluid so that an electro-osmotic force (EOF) effect is generated to drive the fluid to flow, further controlling the moving direction of the particles in the fluid.

According to the present invention, a fluid driving apparatus is provided. The apparatus includes a substrate, at least one electrode group and a controlling unit. The substrate has at least one plane. The electrode group is disposed on the substrate and includes a first electrode, a second electrode and a third electrode. A projecting position of the second electrode on the plane is between a projecting position of the first electrode on the plane and a projecting position of the third electrode on the plane. The controlling unit electrically connected to the electrode group is for driving the first electrode, the second electrode and the third electrode. When the controlling unit drives the first to third electrodes to make a polarity of the first electrode opposite to a polarity of the third electrode and to make a polarity of the second electrode the same as the polarity of the third electrode, an electric field produced by the electrode group enables the fluid on the substrate to flow from the first electrode to the third electrode.

The invention will become apparent from the following detailed description of the preferred but non-limiting embodiments. The following description is made with reference to the accompanying drawings.

### BRIEF DESCRIPTION OF THE DRAWINGS

FIGS. 1A and 1B are diagrams showing a fluid driving apparatus according to a first embodiment of the invention;

FIGS. 2A and 2B are diagrams showing a fluid driving apparatus having more than three electrodes according to the first embodiment of the invention;

FIG. 3A is a diagram showing a fluid driving apparatus according to a second embodiment of the invention;

FIG. 3B shows a partially cross-sectional view of the fluid driving apparatus in FIG. 3A;

FIG. 3C shows a partially enlarged view of the fluid driving apparatus in FIG. 3A;

FIG. 4A shows a cross-sectional view of the electrode group 324 in FIG. 3C;

FIG. 4B shows a cross-sectional view of the electrode group 325 in FIG. 3C;

FIG. 4C is a diagram showing the electrode group 325 in FIG. 4B generating a positive DEP force;

FIGS. 5A and 5B are diagrams showing polygonal electrode groups of a fluid driving apparatus;

FIG. 5C is a diagram showing the separated electrode groups of a fluid driving apparatus similar to that of FIG. 5A;

FIG. 5D is a diagram showing the separated electrode groups of a fluid driving apparatus similar to that of FIG. 5B;

FIG. 6 is a diagram showing a fluid driving apparatus according to a third embodiment of the invention;

FIGS. 7A and 7B show cross-sectional views of a portion of electrode group in FIG. 6 being driven; and

FIGS. 8A to 8C are diagrams showing the fluid driving apparatus in FIG. 6 controlling particles.

### DETAILED DESCRIPTION OF THE INVENTION

### First Embodiment

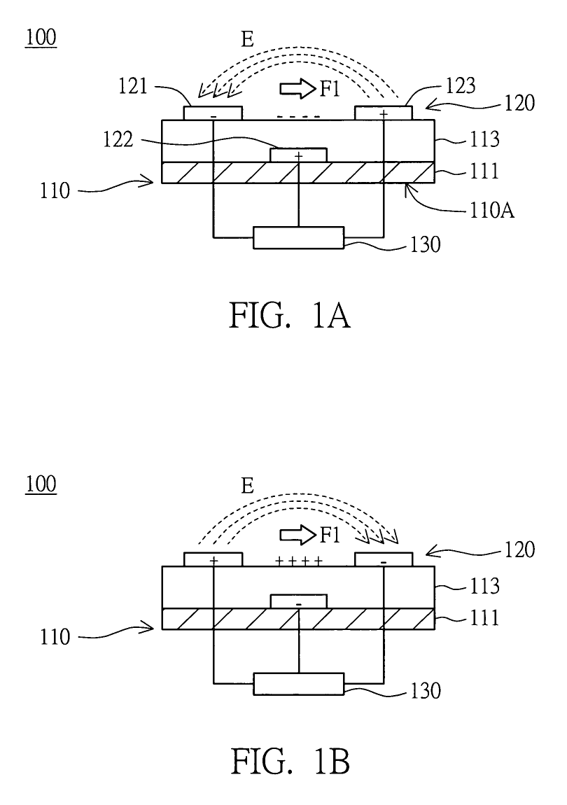

FIGS. 1A and 1B are diagrams showing a fluid driving apparatus 100 according to a first embodiment of the invention. The fluid driving apparatus 100 includes a substrate 110, at least one electrode group 120 and a controlling unit 130. The substrate 110 has at least one plane 110A. The electrode group 120 is disposed on the substrate 110 and includes a first electrode 121, a second electrode 122 and a third electrode 123. A projecting position of the second electrode 122 on the plane 110A is between a projecting position of the first electrode 121 on the plane 110A and a projecting position of the third electrode 123 on the plane 110A. The controlling unit 130 is electrically connected to the electrode group 120 and drives the first electrode 121, the second electrode 122 and the third electrode 123. When the controlling unit 130 drives the first to third electrodes 121, 122 and 123 to make a polarity of the first electrode 121 opposite to a polarity of the third electrode 123, and to make a polarity of the second electrode 122 the same as the polarity of the polarity of the third electrode 123, an electric field produced by the electrode group 120 enables the fluid on the substrate 110 to flow from the first electrode 121 to the third electrode 123.

The substrate 110 includes a base 111 and an insulating layer 113 disposed on the base 111. The material of the base 111 is, for example, silicon or glass. Preferably, the second electrode 122 is overlaid by the insulating layer 113, and the first electrode 121 and the third electrode 123 are disposed on the insulating layer 113, so that the first electrode 121 and the third electrode 123 are disposed on the same horizontal position and the second electrode 122 is disposed below the horizontal position.

The controlling unit 130 provides, for example, an alternating current (AC) voltage to the electrode group 120. The fluid on the substrate 110 is, for example, an electrolyte solution. When the AC voltage of the controlling unit 130 is applied to the second electrode 122, charges are induced in the fluid over the insulating layer 113 and the second electrode 122. If the AC voltage with the same frequency is applied to the first electrode 121 and the third electrode 123 over the insulating layer 113, the first electrode 121 and the third electrode 123 generate an electric field distribution instantly. At this time, the induced fluid carrying the charges is influenced by the electric field so that an electro-osmotic force (EOF) is generated to control the fluid to flow.

As shown in FIG. 1A, when the controlling unit 130 drives the electrode group 120 at a first time instant so that the first electrode 121 and the third electrode 123 have opposite polarities and the second electrode 122 and the third electrode 123 have the same polarity, e.g., the first electrode has the negative polarity, and the third electrode has the positive polarity, the fluid over the second electrode 122 near the insulating layer 113 is induced to generate negative charges. Thus, the electric field E produced by the first electrode 121 and the third electrode 123 enables the fluid carrying the negative charges to flow in the direction F1 toward the third electrode 123 (positive polarity).

At a next time instant, as shown in FIG. 1B, the polarities of the first electrode 121 and the third electrode 123 are switched. That is, the first electrode 121 has a positive polarity and the third electrode 123 has a negative polarity. In the meantime, the direction of the electric field E is opposite to that at the previous time instant, and the fluid near the insulating layer 113 is induced to form positive charges. The fluid carrying the positive charges still flows in the direction toward the third electrode 123 that has the negative polarity. Consequently, the net flows of the fluid in the same direction F1 are generated although the polarity of each electrode is continuously changed under the driving of the AC from the controlling unit 130.

The areas of the first electrode 121, the second electrode 122 and the third electrode 123 are, for example, the same in the embodiment. However, the three electrodes 121 to 123 can occupy the areas of different sizes on the substrate 110, so that when the voltage is applied to each electrode, a corresponding electric field is generated to control the fluid.

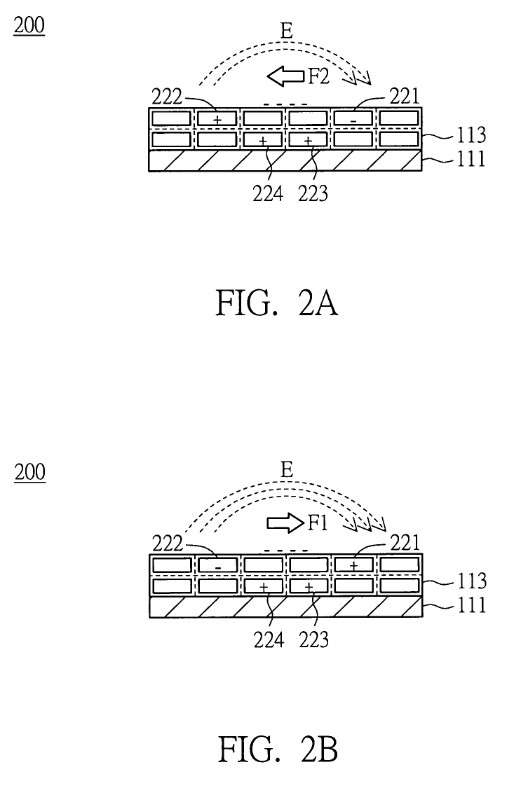

In other embodiments, more electrodes can be disposed on the substrate 110 so as to drive the fluid at different positions of the substrate 110, or to drive the fluid within different ranges to flow. FIGS. 2A and 2B are diagrams showing a fluid driving apparatus 200 having more than three electrodes according to the first embodiment of the invention. The fluid driving apparatus 200 includes several electrodes. The electrodes are, for example, disposed in the insulating layer 113 and above the base 111, and are classified into upper and lower electrodes on the base 111.

As shown in FIG. 2A, the upper electrodes 221 and 222 are driven to have different polarities so that an electric field E is generated at a first instant. And the lower electrodes 223 and 224 near the base 111 are driven to have the same polarity as that of the electrode 222. Consequently, negative charges are induced in the fluid over the electrodes 223 and 224 so that the fluid flows in the direction F2 toward the electrode 222.

At the next time instant, as shown in FIG. 2B, the polarities of the upper electrodes 221 and 222 are switched. Because the negative charges are still induced in the fluid, the fluid carrying the negative charges flows in the direction F1 toward the electrode 221, wherein the direction F1 is opposite to the flowing direction at the previous instant.

When many electrodes are disposed on the substrate 110, they can control the fluid at arbitrary positions on the substrate 110, or drive the fluid within different ranges to flow. Moreover, each of the electrodes can be driven independently, so that the fluid over the substrate 110 can further be controlled to flow in different directions according to the difference between the polarities of the electrodes, the electric fields produced by the electrodes and the charges induced in the fluid.

### Second Embodiment

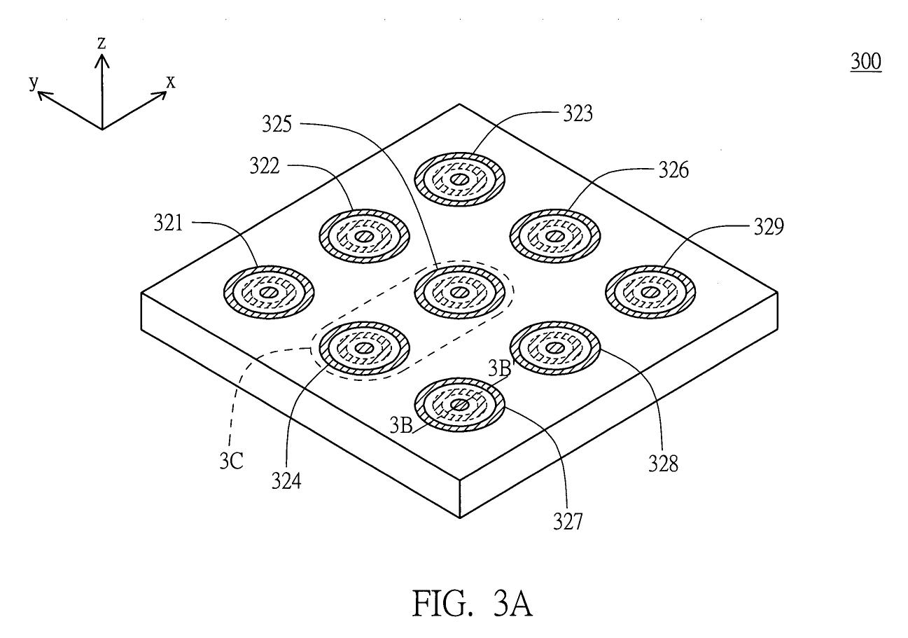

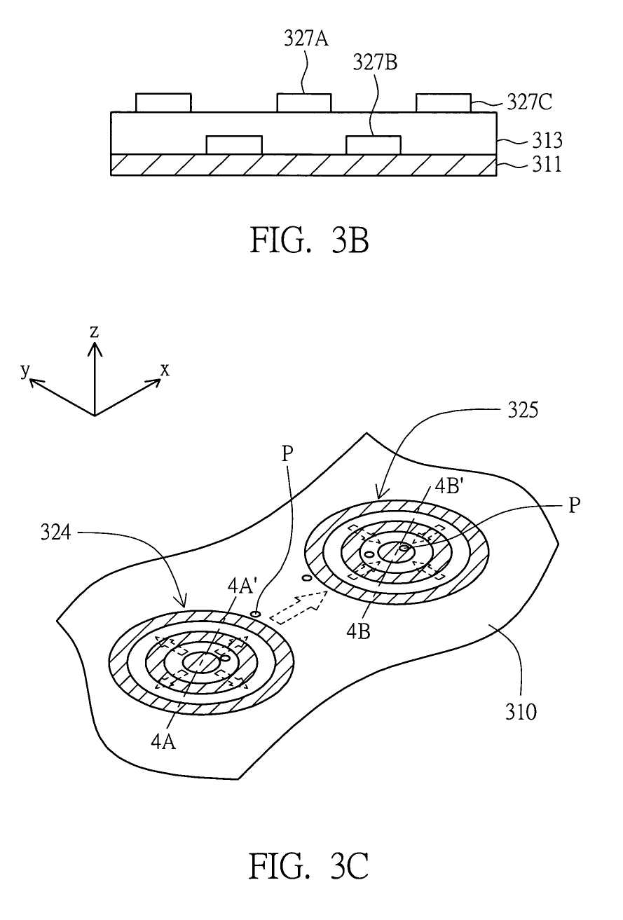

FIG. 3A is a diagram showing a fluid driving apparatus 300 according to a second embodiment of the invention. FIG. 3B shows a partially cross-sectional view of the fluid driving apparatus 300 in FIG. 3A. The fluid driving apparatus 300 includes a substrate 310 and a plurality of electrode groups, such as electrode groups 321 to 329. The electrode groups 321 to 329 are, for example, arranged on the substrate 310 in the form of an array. The structure of each of the electrode groups is the same, and the electrode group 327 is elaborated here. As shown in FIG. 3B, the electrode group 327 includes a first electrode 327A, a second electrode 327B and a third electrode 327C, wherein the second electrode 327B is disposed corresponding to the periphery of the first electrode 327A, and the third electrode 327C is disposed corresponding to the periphery of the second electrode 327B. Preferably, each of the second electrode 327B and the third electrode 327C is a ring-shaped electrode so that the electrodes are disposed on the substrate 310 in concentric circles.

The substrate 310 includes a base 311 and an insulating layer 313. The first electrode 327A and the third electrode 327C are disposed on the insulating layer 313, and the second electrode 327B is disposed between the base 311 and the insulating layer 313. Each electrode of the electrode group 327 is electrically connected to a controlling unit (not shown). The controlling unit provides an AC voltage to each electrode to independently drive the electrode and control its polarity. Since each of the electrodes is driven independently, different electric fields on the substrate 310 are accordingly generated due to the difference in polarity between the electrodes.

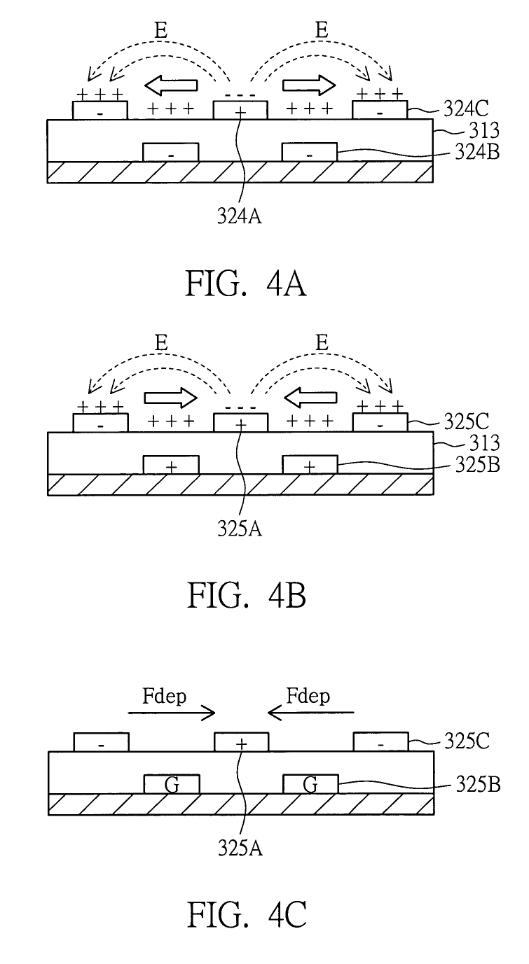

In this embodiment, the operations of the electrode group 324 and the electrode group 325 are elaborated to illustrate the driving of the fluid flow and the movement of the particles in the fluid. FIG. 3C shows a partially enlarged view of the fluid driving apparatus in FIG. 3A. FIG. 4A shows a cross-sectional view of the electrode group 324 in FIG. 3C. FIG. 4B shows a cross-sectional view of the electrode group 325 in FIG. 3C.

As shown in FIG. 4A, when the controlling unit controls a first electrode 324A of the electrode group 324 to have a positive polarity and controls a second electrode 324B and a third electrode 324C to have negative polarities at the first time, the first electrode 324A and the third electrode 324C on the insulating layer 313 form an electric field. And the fluid over the second electrode 324B is induced to generate positive charges. At this time, the fluid carrying the positive charges is influenced by the electric field E to flow in the direction toward the third electrode 324C. Also referring to FIG. 3C, the fluid on the electrode group 324 flows outwardly, and the particle P on the electrode group 324 is moved to the outer circumferential portion of the electrode group 324 together with the fluid.

After the particle P is moved out of the electrode group 324, the driving of the electrode group 324 is stopped and the AC voltage is provided to the electrode group 325. As shown in FIG. 4B, when the controlling unit drives a first electrode 325A and a second electrode 325B of the electrode group 325 such that the first electrode 325A and the second electrode 325B have the positive polarity, and a third electrode 325C has the negative polarity at the second time instant, the first electrode 325A and the third electrode 325C on the insulating layer 313 form an electric field, and the fluid over the second electrode 325B is induced to generate negative charges. At this time, the fluid carrying the negative charges is influenced by the electric field to flow in the direction toward the first electrode 325A. Also referring to FIG. 3C, the fluid on the electrode group 325 flows inwardly, and the particle P at the outer circumferential portion of the electrode group 325 is moved into the area where the electrode group 325 is located on the substrate 310.

In order to position the particle P on the electrode group 325, a suitable voltage and frequency can be applied to specific electrode(s) of the electrode group 325 to generate a positive dielectrophoresis (DEP) force for controlling the particle.

FIG. 4C is a diagram showing the electrode group 325 in FIG. 4B generating a positive DEP force. After the particle P is moved to the electrode group 325, the polarities of the first electrode 325A and the third electrode 325C are held but the second electrode 325B is adjusted to have the zero potential. In addition, properly controlling the dielectric constants of the fluid and the particle P and the frequency of the voltage to make the polarized level of the particle P higher than that of the fluid, the particle P has a tendency to move toward the stronger electric field. Since the electric field intensity on the first electrode 325A is higher than that of the third electrode 325C, the particle P is trapped on the first electrode 325A by the positive DEP force Fdep.

Because the electrode groups 321 to 329 are disposed on the substrate 310 in the form of an array, by turning on and off the electrodes of the electrode groups at different positions of the substrate 310 can properly control the flowing of the fluid as well as the particles in the fluid.

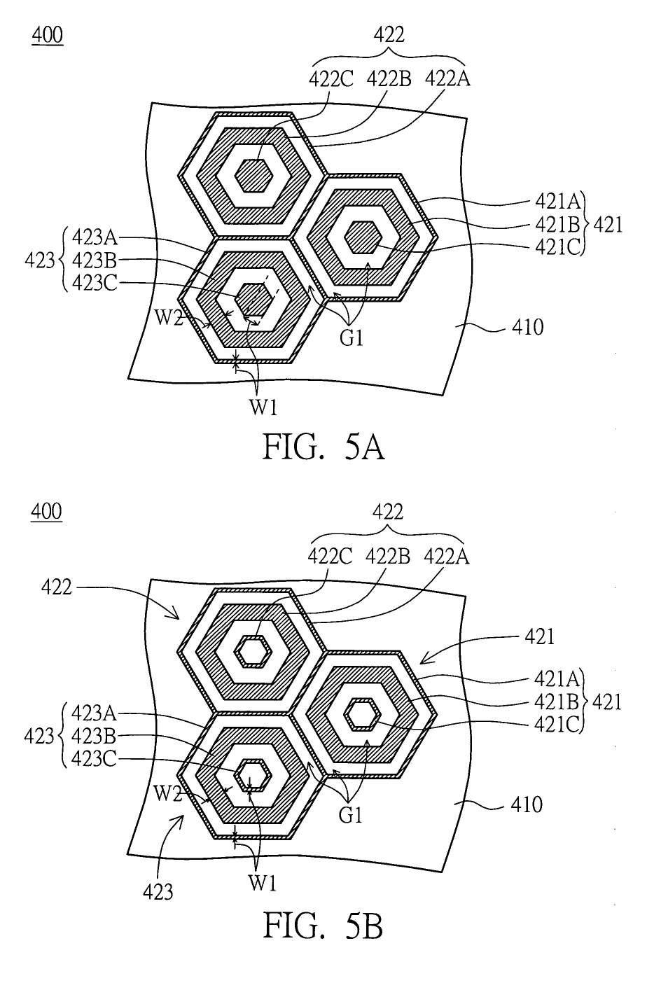

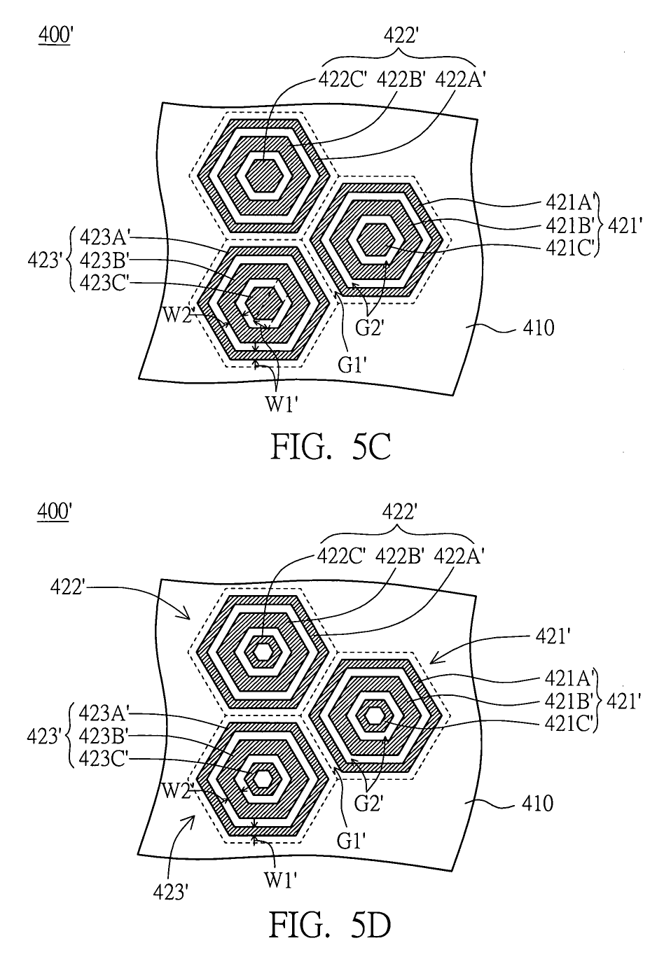

It should be noted that the shape of the electrode is not limited to that of the ring-shaped electrode. And, the electrode groups are not necessary to be disposed in the form of the array. In other embodiments, each of the electrodes can be polygonal. FIGS. 5A and 5B are diagrams showing polygonal electrode groups of a fluid driving apparatus 400. As shown in FIG. 5A, the fluid driving apparatus 400 includes a substrate 410 and a plurality of hexagon electrode groups 421 to 423. Due to the match of the shapes of the electrode groups, the electrodes 421A to 423A at the outermost rings of the electrode groups 421 to 423 are densely connected together, minimizing the gaps between the electrode groups 421, 422 and 423 and thus reducing the size of the substrate 410. Each of the innermost electrodes 421C to 423C has an entire hexagonal structure. The electrodes 421 B to 423B between the electrodes 421A to 423A and the electrodes 421C to 423C also have hexagonal ring-shaped structures, respectively. The dimensions of each electrode of the electrode group 423 are listed in the following. One half of the width of the innermost electrode 423C and the width of the outermost electrode 423A are equal to W1. The gap between the electrodes is equal to G1. The width of the middle electrode 423B is equal to W2, wherein W2>W≧G1. Preferably, W2≧2W1, and W1>2G1. In addition, as shown in FIG. 5B, the innermost electrodes 421C to 423C of the electrode groups 421 to 423 are designed to be the ring-shaped electrodes with the width W1, and the other designed parameters can be the same as those of the electrodes in FIG. 5A.

FIG. 5C is a diagram showing the separated electrode groups of a fluid driving apparatus similar to that of FIG. 5A. FIG. 5D is a diagram showing the separated electrode groups of a fluid driving apparatus similar to that of FIG. 5B. The electrode groups 421′ to 423′ of the fluid driving apparatus 400′ are disposed adjacent to one another but separated from one another. Each of the innermost electrodes 421C′ to 423C′ of the electrode groups 421′ to 423′ have an entire hexagonal structure, as shown in FIG. 5C. Or, each of the electrodes 421C′ to 423C′ is a hexagonal ring-shaped electrode, as shown in FIG. 5D. The dimensions of each electrode of the electrode group 423′ of FIG. 5C are listed in the following. One half of the width of the innermost electrode 423C′ and the width of the outermost electrode 423A′ are equal to W1′. The gap between the electrode groups is equal to G1′, and the gap between the electrodes is equal to G2′. The width of the middle electrode 423B′ is equal to W2′, wherein W2′>W1′≧G1′>G2′. Preferably, W2′≧2W1′, W1′>2G1′ and G1′>2G2′. In FIG. 5D, the width of the electrode 423C′ having the ring-shaped structure is also equal to W1′. Herein, the designed dimensions of the electrodes can be applied to the electrodes of the electrode groups 321 to 329 in FIG. 3A.

### Third Embodiment

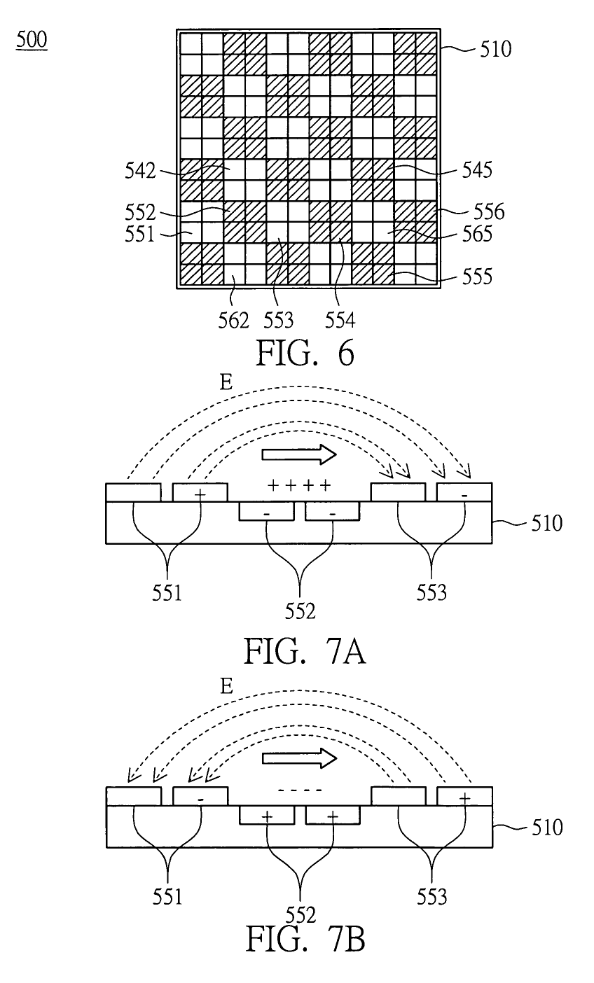

FIG. 6 is a diagram showing a fluid driving apparatus 500 according to a third embodiment of the invention. FIGS. 7A and 7B show cross-sectional views of a portion of the electrode group in FIG. 6 being driven. As shown in FIG. 6, the fluid driving apparatus 500 includes a substrate 510 and a plurality of electrode groups. The electrode groups are arranged on the substrate 510 in the form of an array. Each of the electrode group includes a plurality of electrodes arranged in the form of an array. In this embodiment, four electrodes constituting an electrode group are illustrated as an example. As shown in FIGS. 7A and 7B, the electrode groups on the substrate 510 are classified into upper and lower electrodes, and are disposed alternately. Take the lower electrode group 552 for example. The upper, lower, left and right electrode groups 542, 562, 551 and 553 adjacent to the lower electrode group 552 are disposed on the upper location of the substrate 510. And the electrode groups 545, 556, 555 and 554 adjacent to the upper electrode group 565 are disposed on the lower location of the substrate 510.

Each of the electrode groups is electrically connected to a controlling unit (not shown). The controlling unit provides an AC voltage to independently drive each electrode and to properly change its polarity. Although four electrodes constituting one group are illustrated in this embodiment, since each electrode is independently connected to the controlling unit, the controlling unit can choose to drive a single electrode in one electrode group at a time or drive several electrodes simultaneously. In addition, the number of electrodes in each electrode group is not restricted to four.

When driving the fluid to flow, by means of the electric field E produced by the upper electrodes and the induced charges near the lower electrodes, the fluid carrying the charges flows under the effect of the electric field E. Herein, the operations of the electrode groups 551, 552 and 553 of the fluid driving apparatus 500 are described as an example. As shown in FIGS. 7A and 7B, the electrode group 553 is disposed on the lower location of the substrate 510, and the electrode groups 551 and 553 are disposed on the upper location of the substrate 510.

In FIG. 7A, when the controlling unit drives the upper electrode groups 551 and 553 at a first time instant to make some electrodes thereof have positive and negative polarities, the driven electrodes generate the electric field E on the substrate 510. When the controlling unit makes the electrodes of the lower electrode group 552 have negative polarity, the fluid thereon is induced to generate positive charges. Consequently, the fluid is influenced by the EOF and flows in a direction toward the electrode group 553. At the next instant, as shown in FIG. 7B, the AC voltage provided by the controlling unit makes the polarities of the electrodes be opposite to that at the previous instant. However, because the direction of the electric field reverses, and the polarity of the lower electrode also changes, so that the net flows of fluid in the same direction is still generated.

The electrodes on the substrate 510 are arranged in the form of an array, the fluid flows along a designed path as long as the voltage is applied to at least one specific electrode group or at least one individual electrode.

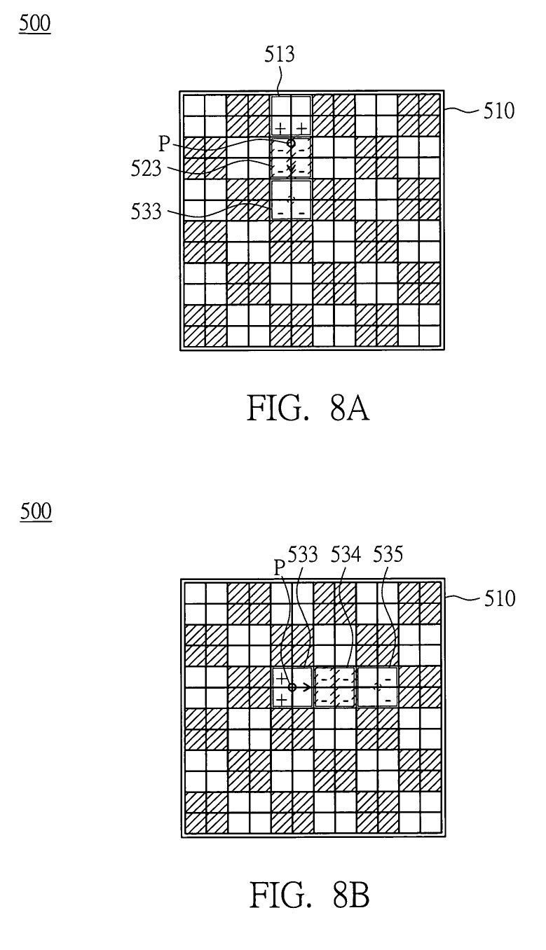

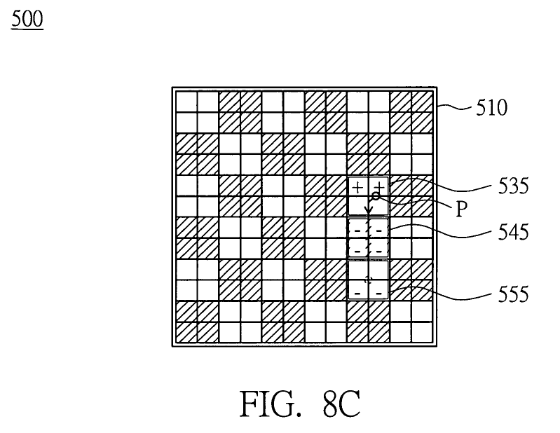

The fluid driving apparatus 500 of this embodiment is capable of controlling the movement of particles on the substrate 510. FIGS. 8A to 8C are diagrams showing the fluid driving apparatus in FIG. 6 controlling the particles. The fluid carrying the particle P is, for example, disposed over the electrode group 523 of the substrate 510. When controlling the fluid with the particle P to move in a specific direction, the electrodes of the electrode groups on the moving path of the particle P are driven to have different polarities. As shown in FIG. 8A, some electrodes of the upper electrode groups 513 and 533 have opposite polarities to form the electric field, and the polarity of the electrode of the lower electrode group 523 is the same as the polarity of the electrode of the electrode group 533. Consequently, the fluid with the induced charges flows in a direction toward the electrode group 533 to thereby take the particle P away.

After the particle P is moved to the location above the electrode group 533, the number and positions of the electrodes or the electrode group driven by the controlling unit are then changed, so as to move the particle P in different direction. As shown in FIG. 8B, the electrodes of the electrode group 533 are driven, and the polarities of some electrodes of the upper electrode group 535 are controlled to be opposite to the polarity of the electrode group 533, so that another electric field is formed. In addition, the lower electrode group 534 and the upper electrode group 535 have the same polarity, so that the fluid controls the particle P to move in a direction toward the electrode group 535. As shown in FIG. 8C, after the particle P is moved to the location above the electrode group 535, the controlling unit then switches the electrode groups 535, 545 and 555 to drive the particle P to move in other direction.

A sensing unit can be used in each of the fluid driving apparatuses 100 to 500 in the first to third embodiments for momentarily monitoring the positions of the particles on the substrate to assist in controlling the movement of the particles. The sensing unit transmits a signal to the controlling unit whenever sensing the positions of the particles, so that the controlling unit determines whether the positions and the number of the electrode groups to be driven are changed, controlling the movement of the particles on the substrate. Moreover, micro-channels can be formed on the substrate to cooperate with the electrode groups, and are helpful to the operation of controlling the particles. The fluid driving apparatuses are suitable for being applied in the biometric, medical, nanometer or MEMS fields for controlling, classifying and counting particles.

The fluid driving apparatus disclosed in each embodiment of the invention controls the polarities of the electrodes to form the electric field, and the charges are induced in the fluid adjacent to the electrodes so that the EOF effect is generated to drive the fluid to flow. The electrodes on the substrate are arranged in the form of an array or not in the form of an array. Thus, the fluid is capable of flowing on the substrate along different paths as well as moving the particles.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for driving a fluid, the apparatus comprising:
a substrate having at least one plane;
at least one electrode group, which is disposed on the substrate and includes at least one first electrode, a second electrode and a third electrode, wherein a projecting position of the second electrode on the plane is between a projecting position of the first electrode on the plane and a projecting position of the third electrode on the plane; and
a controlling unit, electrically connected to the electrode group, for driving the first electrode, the second electrode and the third electrode;
wherein when the controlling unit drives the first to third electrodes to make a polarity of the first electrode opposite to a polarity of the third electrode and to make a polarity of the second electrode the same as the polarity of the third electrode, an electric field produced by the electrode group enables the fluid on the substrate to flow from the first electrode to the third electrode.

2. The apparatus according to claim 1, wherein the fluid is an electrolyte solution.

3. The apparatus according to claim 1, wherein the second electrode is disposed corresponding to a periphery of the first electrode, and the third electrode is disposed corresponding to a periphery of the second electrode.

4. The apparatus according to claim 3, wherein the second electrode and the third electrode are ring-shaped electrodes.

5. The apparatus according to claim 4, wherein the first electrode is a ring-shaped electrode.

6. The apparatus according to claim 4, wherein each of the first electrode, the second electrode and the third electrode has a polygonal structure.

7. The apparatus according to claim 1, wherein the electrode group further comprises a fourth electrode electrically connected to the controlling unit.

8. The apparatus according to claim 7, wherein the first electrode, the second electrode, the third electrode and the fourth electrode are disposed on the substrate in the form of an array.

9. The apparatus according to claim 1, further comprising:
a plurality of electrode groups disposed on the substrate in the form of an array.

10. The apparatus according to claim 1, wherein the first electrode and the third electrode are disposed at the same horizontal position of the substrate, and the position of the second electrode is lower than the horizontal position.

11. The apparatus according to claim 1, wherein the substrate comprises a base and an insulating layer disposed on the base.

12. The apparatus according to claim 11, wherein the second electrode is overlaid by the insulating layer, and the first electrode and the third electrode are disposed on the insulating layer.

13. The apparatus according to claim 1, wherein the controlling unit comprises an alternating current (AC) power.
